(19) United States
(12) Patent Application Publication
(10) Pub. No.: US 2012/0203820 A1
(43) Pub. Date: Aug. 9, 2012

(54) PREDICTING WORKLOAD BY PER LOOK BASED DATA

(75) Inventors: Erik J. Burckart, Raleigh, NC (US); Lisa Seacrat DeLuca, San Francisco, CA (US); Andrew Ivory, Wake Forest, NC (US); Aaron K. Shook, Raleigh, NC (US)

(73) Assignee: INTERNATIONAL BUSINESS MACHINES CORPORATION, Armonk, NY (US)

(21) Appl. No.: 13/020,114

(22) Filed: Feb. 3, 2011

(51) Int. Cl. G06F 15/16

(52) U.S. Cl. 709/203

(57) ABSTRACT

Provided are techniques to track a user's attention with respect to elements displayed on a computer screen, correlate the elements to resources and pre-fetch the resources prior to a user request to access the resource. Data storage is allocated for the fetching of content that the user is anticipated to access and a business is notified of a user's interest in an advertisement so that the business may make purchasing, warehousing and shipping decisions.

### FIELD OF DISCLOSURE

The claimed subject matter relates generally to webpage management and, more specifically, to anticipating specific content on a web page that has a high probability of being accessed and allocating resources corresponding to the content.

### SUMMARY

Provided are techniques for analyzing how a user is accessing a web page and, based upon that analysis, allocating resources for items that have yet to be accessed. Current systems provide a user with content, within which are links to other content. As a viewer scans a webpage, certain items are of more interest than others. For example, at the main page of a typical news site, there is typically one section with headlines, each headline providing a link to a corresponding news story, and a portion of one or more “top” stories presented such that a summary of the story is provided with a link at the bottom to the “Full Story.” When a user clicks on a headline or a “Full Story” link, the corresponding story is loaded into memory and presented on the screen for viewing. A complete story is typically not loaded into memory until the user follows a link in the main page and a complete story cannot be displayed until loaded into memory. The loading of a story into memory creates a delay before the user may view the story.

In addition, on a typical news site, much content is dynamic, i.e. stories are frequently being updated. By its very nature, dynamic content is very difficult to intelligently and effectively cache because of the frequent changes. In other words, it is difficult to allocate resources in anticipation that a user will be accessing the content because, by the time the viewer clicks on the corresponding link, the content may have changed and the resources are outdated.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures, in which:

FIG. 1 is a block diagram of a computing system architecture that may implement the claimed subject matter.

FIG. 2 is a block diagram of an Eye Tracking and Content Anticipation server (ETCAS), first introduced in conjunction with FIG. 1 that may implement the claimed subject matter.

FIG. 3 is an illustration of a web page that may be implemented in accordance with the claimed subject matter.

FIG. 4 is a flow chart of a Setup Tracking process that implements one aspect of the claimed subject matter.

FIG. 5 is a flow chart of a User Tracking and Resource Allocation (UTRA) process that implements aspects of the claimed subject matter.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc. or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

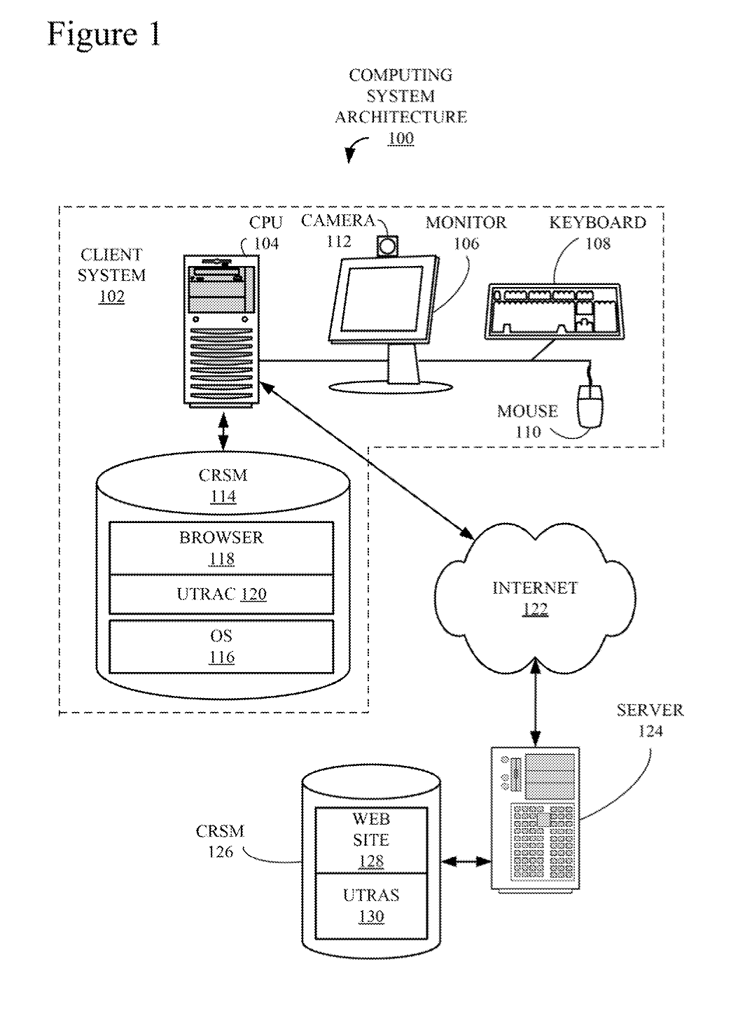

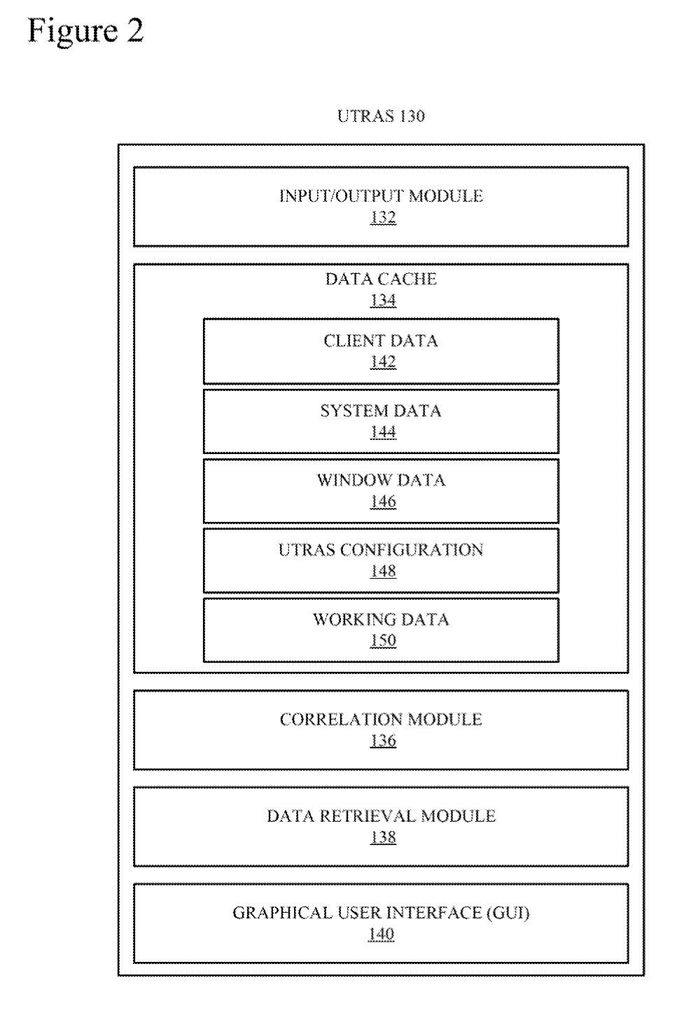

Turning now to the figures, FIG. 1 is a block diagram of an example of a computing system architecture 100 that incorporates the claimed subject matter. A client system 102 includes a central processing unit (CPU), or “processor,” 104, coupled to a monitor 106, a keyboard 108 and a tracking device, or “mouse,” 110, which together facilitate human interaction with computing system 100 and client system 102. Coupled to client system 102 and attached to monitor 106 is a camera 112. Also included in client system 102 and attached to CPU 104 is a computer-readable storage medium (CRSM) 114, which may either be incorporated into client system 102 i.e. an internal device, or attached externally to client system 102 by means of various, commonly available connection devices such as but not limited to, a universal serial bus (USB) port (not shown). CRSM 114 is illustrated storing an operating system (OS) 116, a web browser application, or “browser,” 118 and a User Tracking and Resource Allocation Client (ETRAC) 120. OS 116 and browser 118 will be familiar to those with skill in the relevant arts. UTRAC 120 implements aspects of the claimed subject matter and is explained in more detail below in conjunction with FIGS. 2-5.

Client system 102 and CPU 104 are connected to the Internet 122, which is also connected to a web server, or “server,” 124. Although in this example, CPU 104 and server 124 are communicatively coupled via the Internet 122, they could also be coupled through any number of communication mediums such as, but not limited to, a local area network (LAN) (not shown). Further, it should be noted there are many possible computing system configurations, of which computing system 100 is only one simple example.

Like client system 102, server 124 would include a CPU, monitor, keyboard and mouse, which, for the sale of simplicity, are not illustrated. Also coupled to server 124 is a CRSM 126. Like CRSM 114, CRSM 126 may either be incorporated into server 124 i.e. an internal device, or attached externally to server 124 by means of various, commonly available connection devices such as but not limited to, a universal serial bus (USB) port (not shown). CRSM 126 is illustrated storing data and logic associated with providing a web site 128 and a User Tracking and Resource Allocation Server (UTRAS) 130. UTRAS 130 implements aspects of the claimed subject matter and is described in more detail below in conjunction with FIGS. 2-5.

FIG. 2 is a block diagram of UTRAS 130, first introduced in conjunction with FIG. 1, in more detail. In the following examples, UTRAS 130 is stored on CRSM 126 (FIG. 1) and executed on a processor (not shown) of server 124 (FIG. 1). It should be noted that the functionality associated with the claimed subject matter may be distributed between UTRAC 120 and UTRAS 130 many different ways. However, in the following description, UTRAC 120 is responsible for collecting data client system 102 (FIG. 1), including, but not limited to, the identity and positions of open windows on monitor 106, data from camera 112 (FIG. 1), and storing files transmitted from server 124 into CRSM 114 for predicted use by browser 118 (FIG. 1) and UTRAS 130 is primarily responsible for the remainder of the processing. In other words, for the sake for simplicity, much of the disclosed technology is described as being executed by UTRAS 130 although in an alternative embodiment much could be executed by UTRAC 120 instead. Those with skill in the relevant arts will appreciate that there are many possible options with respect to the distribution of work in a client/server architecture.

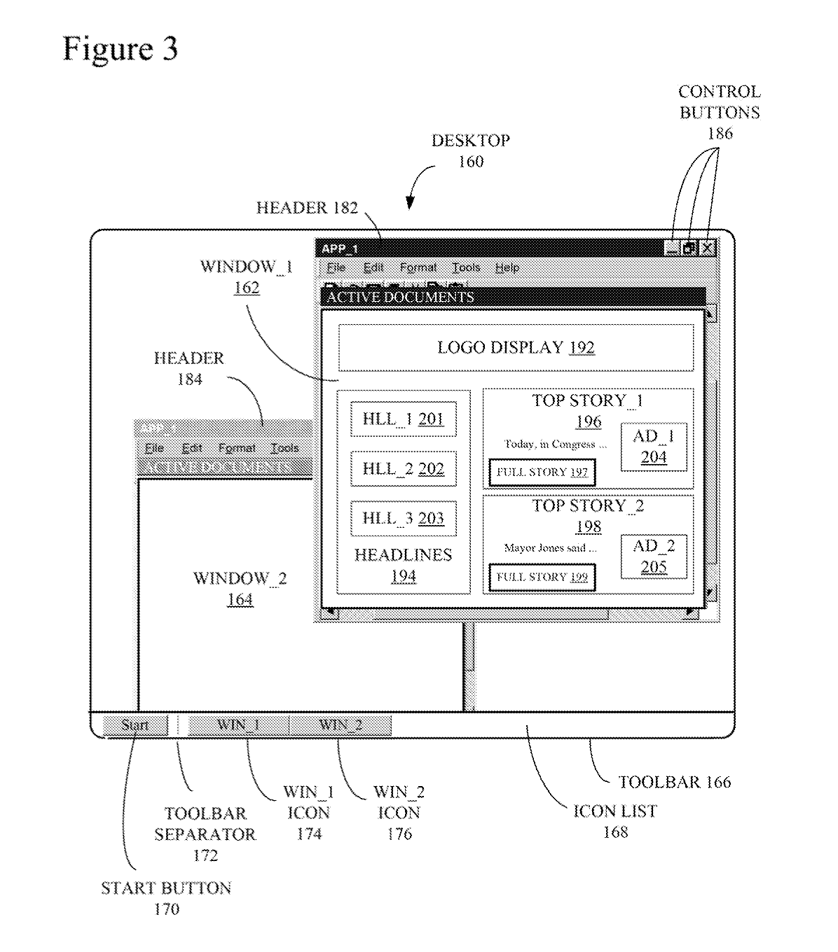

UTRAS 130 includes an input/output (I/O) module 132, a data cache 134, a correlation module 136, a data retrieval module 138 and a graphical user interface (GUI) 140. I/O module 132 handles any communication UTRAS 130 has with other components of system 100. Data cache 134 is a data repository for information, including settings and other information, that UTRAS 130 requires during normal operation. Examples of the types of information stored in data cache 142 include client data 142, system data 144, window data 146, UTRAS Configuration 148 and working data 150. Client data 142 stores information on clients, such as client system 102, that may implement the claimed technology. Such client information may also include historical information relating to a number of users and access patterns associated with the users. System data 144 stores information on the configuration of computing system architecture 100. Window data 146 stores information on windows (see FIG. 3) that may be open within system 100 and actively employing the claimed subject matter. Such information, includes, but is not limited to, information on the content of open windows and the relationships among the content. For example, related items in a news article displayed in one window may include one or more display ads and a “FULL STORY” button. UTRAS Configuration 148 is stores information, primarily defined be a system administrator, for controlling the operation of UTRAS 130. Working data 150 is information that UTRAS 130 employs during operation including the results of intermediate calculations.

Correlation module 136 is employed by UTRAS 130 to correlate information gathered by a user tracking device, e.g. camera 112 (FIG. 1), and UTRAC 120 with elements of an open window (see FIG. 3). Data retrieval module 138 includes logic for retrieving from storage and transmitting to client system 102 content or data that correlation module 136 determines may be needed by the user of client system 102. GUI 140 enables a system administrator to interact with UTRAS 130 and to define the desired functionality of UTRAS 130.

It should be understood that the claimed subject matter can be implemented in many types of computing systems and data storage structures but, for the sake of simplicity, is described only in terms of computer 102, server 124 and system architecture 100 (FIG. 1). Further, the representation of UTRAS 130 in FIG. 2 is a logical model. In other words, components 132, 134, 136, 138 and 140 may be stored in the same or separates files and loaded and/or executed within server 124 and system 100 either as a single system or as separate processes interacting via any available inter process communication (IPC) techniques. Components 132, 134, 136, 138, 140, 142, 144, 148 and 150 are described in more detail below in conjunction with FIGS. 3-5.

FIG. 3 is an illustration of a display, or “desktop,” 160 rendered on monitor 106 (FIG. 1) of client system 102 (FIG. 1) that may be implemented in accordance with the claimed subject matter. Desktop 160 is employed as an example throughout the remainder of this Description. In this example, desktop 160 is part of a GUI displayed in conjunction with OS 116 (FIG. 1).

A toolbar 166 extends along the bottom of desktop 160 from the left edge to the right edge of the screen associated with monitor 106. Within toolbar 166 are a “Start” button 170 and a toolbar separator 172. To the right of toolbar separator 172 is an icon list 168. Icon list 168 displays icons that indicate the corresponding applications or utilities that are currently loaded and executing on client system 102. Included in this example are a Win_1 icon 174, corresponding to a window_1 162 and an icon_2 176, corresponding to a window_2 164.

A certain amount of control, such as terminating execution and maximizing or minimizing a window associated with an application, may be exercised when the user positions a cursor (not shown) over a particular icon 170, 174 or 176 and presses, or “clicks,” a button (not shown) on a clicking device, such as mouse 110 (FIG. 1). Those with skill in the computing arts should be familiar with toolbars and icon areas as well as the use of a mouse and cursor to initiate actions on client system 102. Further, it should be understood that icons are sometimes referred to as “buttons” in that actions occur when icons are clicked in much the same way that actions occur when physical buttons, such as those on mouse 110, are pressed.

In FIG. 3, desktop 160 is displaying two (2) windows, i.e. window_1 162 and window_2 164. In this example, window_1 162 is the active window in desktop 160, as evidenced by the fact that a corresponding header 182 is darker than a header 184 associated with window_2 164. Window_1 162 is illustrated displaying a typical web news site, used for the purpose of illustration only. It should be noted that windows 162 and 164 and any displayed content are used only as examples to describe the functionality of the claimed subject matter and that the claimed subject matter would be equally applicable to other types of web sites. It should also be understood that the claimed subject matter is applicable to displays other than web pages.

Included in header 182 of window_1 162 are control buttons 186. Control buttons 186, which are grouped together for the sake of simplicity, are standard window control buttons that should be familiar to those with skill in the computing arts. Specifically, control buttons 186 include individual buttons for minimizing, maximizing and terminating corresponding window 162. It should be noted that window_2 164 include buttons like buttons 186. In the case of window_1 164, the buttons are obscured by window_1 162.

Displayed in window_1 162 are a logo display 192, a headlines section, or “headlines,” 194, a top story_1 196 and a top story_2 198. Headlines 194, top story_1 196 and top story_2 198 are provided as examples of that which might be displayed on a typical web page. Within headlines 194 are several headline links, i.e. a HLL_1 201, a HLL_2 202 and a HLL_3 203. Each of links 201-203 display a title of a corresponding story and a link so that a user may display the entire story by clicking on the corresponding link. In each of top stories sections 196 and 198, there is the beginning of a story, or “Today, in Congress . . . ” and “Mayor Jones said . . . ,” respectively, and a link so that a user may display the rest of the story, or “Full Story” buttons 197 and 199, respectively. Each of top stories sections 196 and 198 also includes a display advertisement, i.e. ad_1 204 and ad_2 205, respectively.

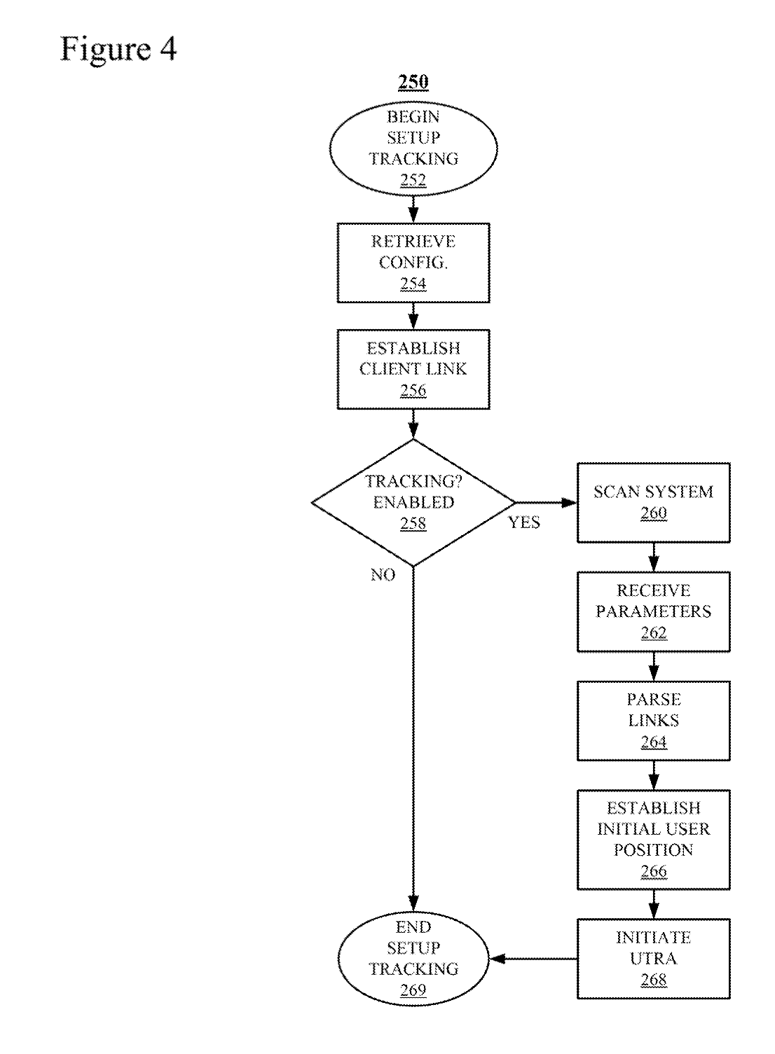

FIG. 4 is a flow chart of a Setup Tracking process 250 that implements one aspect of the claimed subject matter. In this example, process 250 is stored on CRSM 126 (FIG. 1) and executed on server 124 (FIG. 1) as part of UTRAS 130 (FIGS. 1 and 2) in conjunction with the display of web site 128 (FIG. 1) on monitor 106 (FIG. 1) of client system 102 (FIG. 1). In addition, web site 128 is responsible for the transmission of information associated with widow_1 162 (FIG. 3) and the corresponding elements. It should be note that some aspects of process 250 are executed in conjunction with UTRAC 120 (FIG. 1) on client system 102 (FIG. 1)

Process 250 starts in a “Begin Setup Tracking” block 252 and proceeds immediately to a “Retrieve Configuration (Config.)” block 254. During processing associated with block 254, configuration data is retrieved by UTRAS 130, including data corresponding to UTRAS 130 itself (see 148, FIG. 2), potential client systems that may utilize the disclosed technology (see 142, FIG. 2) and the system in which UTRAS 130 is operating (see 144, FIG. 2). During processing associated with an “Establish Client Link” block 256, one of the clients listed in client data 142 (FIG. 2) has established a connection with web site 128 for the exchange of data. Typically, this connection is made between UTRAS 130 and a corresponding client such as UTRAC 120 (FIG. 1). It should be noted that although process 250 only illustrates the setup of the disclosed techniques with respect to one (1) client, i.e. client system 102, and one window, i.e. winfow_1 162, typically UTRAS 130 might handle the management of multiple windows on multiple clients and possibly multiple systems.

During processing associated with a “Tracking Enabled?” block 258, a determination is made by UTRAS 130 as to whether or not a UTRAC such as UTRAC 120 on client system 102 is currently tracking user movement such as eye and/or hand movement in accordance with the claimed subject matter. If so, during processing associated with a “Scan System” block 260, UTRAC 120 on client system 102 determines active windows and the corresponding elements (se FIG. 3). During processing associated with a “Receive Parameters” block 262, UTRAS 130 receives the parameters associated with the scan done by UTRAC 120 during processing associated with block 260.

During processing associated with a “Parse Links” block 264, the elements of the active windows on client system 102 are correlated with stored data (see 136, FIG. 2) by UTRAS 130. For example, each of headline links 201-203 (FIG. 3) may be associated with a corresponding text file stored on CRSM 126 (FIG. 1) and each of display ads 204 and 205 may be associated with a particular vendor's web site (not shown) or server (not shown). During processing associated with an “Establish Initial Position” block 266, a determination is made from information transmitted from UTRAC 120 based upon a signal from camera 112 (FIG. 1) as to what particular element of desktop 160 (FIG. 3) the user of client system 102 is currently focusing.

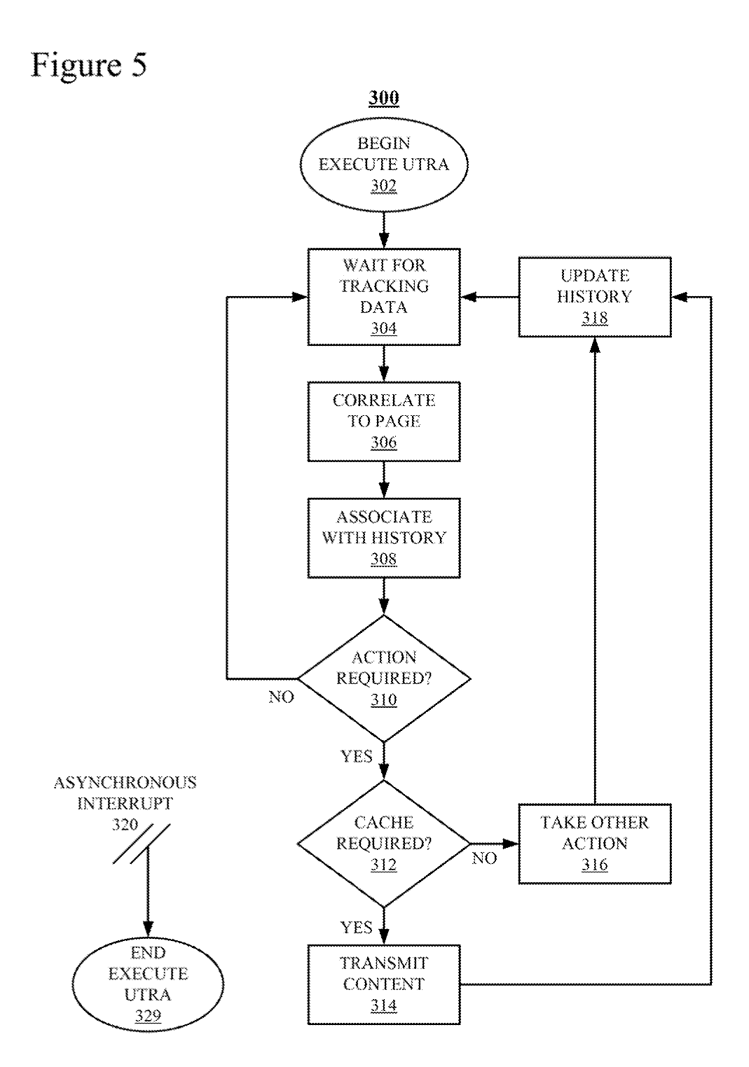

During processing associated with an “Initiate User Tracking and Resource Allocation (UTRA)” block 254, a UTRA process 300 (see FIG. 5) that commences the claimed techniques based upon the information collected and processed during process 250. Finally, once UTRA 300 has been initiated or, if it has been determined during processing associated with block 258 that tracking is not currently enabled, control proceeds to an “End Setup Tracking” block 269 in which process 250 is complete.

FIG. 5 is a flow chart of a User Tracking and Resource Allocation (UTRA) process 300 that implements aspects of the claimed subject matter. Like process 250 (FIG. 4), process 300 is stored on CRSM 130 (FIG. 1) and executed on server 124 (FIG. 1) as part of UTRAS 130 (FIGS. 1 and 2) in conjunction with the display of web site 128 (FIG. 1) on monitor 106 (FIG. 1) of client system 102 (FIG. 1). It should be note that some aspects of process 300 are executed in conjunction with UTRAC 120 (FIG. 1) on client system 102 (FIG. 1).

Process 300 starts in a “Begin Execute UTRA” block 302 and proceeds immediately to a “Wait for Tracking Data” block 304. During processing associated with block 304, information is received by UTRAS 130 from, in this example, UTRAC 120 (FIG. 1) indicating that a user tracking event has been detected. Examples of such events include, but are not limited to, movement of mouse 110 (FIG. 1), selection of a particular element on desktop 160 and detection that the user is viewing a particular element based upon data from camera 112 (FIG. 1). During processing associated with a “Correlate to Page” block 306, the relationship of the event detected during processing associated with block 304 and the elements of desktop 160 such as, in this example, the web page associated with window_1 162 (FIG. 3) are correlated with each other. In other words, based upon knowledge of the elements of desktop 106 and the tracking data received during processing associated with block 304, the elements of desktop 160 that are currently being reviewed is determined.

During processing associated wit an “Associated with History” block 308, the element identified during processing associated with block 306 is correlated with prior actions with respect to the identified element. For example, it may be determined that the element has already been accessed and thus determine during an “Action Required?” block 310 that no action is necessary. In addition, historical information may include information related to the actions of other users with respect to particular display elements. For example, if historical data indicates that fifty percent (50%) of other users that view a particular element request a second particular element, the second particular element is a good candidate for caching prior to a specific request for the second element. If it is determined that no action is necessary, control returns to block 304 and processing continues as described above. Of course, during processing associated with block 310, it may be determined that action, such as the transmission of data is necessary. If so, control proceeds to a “Cache Required?” block 312. During processing associated with block 312, it is determined whether or not the action detected as necessary during processing associated with block 310 is the transmission of data. For example, it may be determined during processing associated with block 306 that the user is reading Top Story_1 196 (FIG. 3) and determined during processing in association with block 308 that the user has not accessed Top Story_1 196 previously. At this point, it is determined that content associated with Full Story button 197 (FIG. 3) should be transmitted to client system 102 in anticipation that the user will ultimately request the content. In addition, action may be required if historical data indicates a likelihood that a particular element will be requested.

During processing associated with a “Transmit Content” block 314, the anticipated content is transmitted to client system 102. If, during processing associated with block 312 that the action required is not the transmission of anticipated content, control proceeds to a “Take Other Action” block 316. During processing associated with block 316, an action appropriate to the particular circumstances may be initiated. For example, if it has been determined that the user is viewing ad_1 204 (FIG. 3), a notification may be transmitted to a company associated with a product featured in ad_1 204 to enable the company to better anticipate user demand and thus stock up on a certain product. Following processing associated with blocks 314 and 316, process 300 proceeds to an “Update History” block 318. During processing associated with block 318, historical information related to the element or elements identified during processing associated with block 306 is updated. In addition to information relating to the current session, a particular access pattern related to the current user may be stored in conjunction with access patterns of other users to provide a means to predict future display access requests.

Finally, process 300 is halted by means of an interrupt 320, which passes control to an “End Execute UTRA” block 329 in which process 300 is complete. Interrupt 320 is typically generated when the OS, browser, application, etc. of which process 300 is a part is itself halted. During nominal operation, process 300 continuously loops through the blocks 304, 306, 308, 310, 312, 314, 316 and 318, processing tracking.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim:

1. A method, comprising:
collecting display information relating to position and content of a plurality of elements displayed on a display device;
gathering focus information indicating a focus of attention of a user relating to the plurality of display elements;
correlating the display information with the focus information to identify a particular display element of the plurality of elements displayed on the display device; and
allocating, in response to the correlating, a resource to the particular element prior to receiving an access request corresponding to the particular display element.

2. The method of claim 1,
wherein the particular display element corresponds to a Uniform Resource Identifier (URI); and
wherein the allocating comprises fetching a web page corresponding to the URI.

3. The method of claim 1,
wherein the particular display element is an advertisement corresponding to a product link; and
wherein the allocating comprises allocating resources to service a request for a product corresponding to the product link.

4. The method of claim 3, the allocating resources to service a request further comprising notifying a business associated with the product.

5. The method of claim 1, the gathering of focus information indicating a focus of attention of the user comprising tracking eye movement corresponding to the user.

6. The method of claim 1, the gathering of focus information indicating a focus of attention of the user comprising tracking hand movement and gestures corresponding to the user.

7. The method of claim 1, the correlating further comprising correlating the display information with historical information corresponding to access patterns of other users with respect to the display information.

8. An apparatus, comprising:
a processor;
a display device;
a computer-readable storage medium; and
logic, stored on the computer-readable storage medium and executed on the processor, for:
collecting display information relating to position and content of a plurality of elements displayed on the display device;
gathering focus information indicating a focus of attention of a user relating to the plurality of display elements;
correlating the display information with the focus information to identify a particular display element of the plurality of elements displayed on the display device; and
allocating, in response to the correlating, a resource to the particular element prior to receiving an access request corresponding to the particular display element.

9. The apparatus of claim 8,
wherein the particular display element corresponds to a Uniform Resource Identifier (URI); and
wherein the allocating comprises fetching a web page corresponding to the URI.

10. The apparatus of claim 8,
wherein the particular display element is an advertisement corresponding to a product link; and
wherein the allocating comprises allocating resources to service a request for a product corresponding to the product link.

11. The method of claim 10, the logic for allocating resources to service a request further comprising logic for notifying a business associated with the product.

12. The apparatus of claim 8, the logic for gathering of focus information indicating a focus of attention of the user comprising logic for tracking eye movement corresponding to the user.

13. The apparatus of claim 8, the logic for gathering of focus information indicating a focus of attention of the user comprising logic for tracking hand movement and gestures corresponding to the user.

14. The apparatus of claim 8, the logic for correlating further comprising logic for correlating the display information with historical information corresponding to access patterns of other users with respect to the display information.

15. An computer programming product, comprising:
a computer-readable storage medium; and
logic, stored on the computer-readable storage medium for execution on a processor, for:
collecting display information relating to position and content of a plurality of elements displayed on a display device;
gathering focus information indicating a focus of attention of a user relating to the plurality of display elements;
correlating the display information with the focus information to identify a particular display element of the plurality of elements displayed on the display device; and
allocating, in response to the correlating, a resource to the particular element prior to receiving an access request corresponding to the particular display element.

16. The computer programming product of claim 15,
wherein the particular display element corresponds to a Uniform Resource Identifier (URI); and
wherein the allocating comprises fetching a web page corresponding to the URI.

17. The computer programming product of claim 15,
wherein the particular display element is an advertisement corresponding to a product link; and
wherein the allocating comprises allocating resources to service a request for a product corresponding to the product link.

18. The computer programming product of claim 15, the logic for gathering of focus information indicating a focus of attention of the user comprising logic for tracking eye movement corresponding to the user.

19. The computer programming product of claim 15, the logic for gathering of focus information indicating a focus of attention of the user comprising logic for tracking hand movement and gestures corresponding to the user.

20. The computer programming product of claim 15, the logic for correlating further comprising logic for correlating the display information with historical information corresponding to access patterns of other users with respect to the display information.
